(19) United States
(12) Patent Application Publication
(10) Pub. No.: US 2026/0238836 A1
(43) Pub. Date: Aug. 13, 2026

(54) VIDEO-PICTURE HYBRID STORAGE METHOD, APPARATUS AND SYSTEM

(71) Applicant: NANJING ALLCAM INFORMATION TECHNOLOGY CO., LTD., Nanjing, Jiangsu (CN)

(72) Inventors: Xin HE, Nanjing, Jiangsu (CN); Ming PANG, Nanjing, Jiangsu (CN); Fan SU, Nanjing, Jiangsu (CN); Cong WANG, Nanjing, Jiangsu (CN); Chaowei YUE, Nanjing, Jiangsu (CN)

(21) Appl. No.: 19/153,914

(22) PCT Filed: Dec. 28, 2023
(86) PCT No.: PCT/CN2023/142705

§ 371 Date: Aug. 5, 2025

(30) Foreign Application Priority Data
Jul. 12, 2023 (CN) 202310848630.3

(51) Int. Cl. H04N 21/218

(52) U.S. Cl. CPC H04N 21/2182

(57) ABSTRACT

Disclosed in the present disclosure are a video-picture hybrid storage method, apparatus and system. The video-picture hybrid storage method comprises: acquiring first information collected by a first camera, the first information comprising videos, pictures and intelligent metadata; on the basis of a preset time period, storing the first information into a disk; storing position information corresponding to the first information into a first server; and, on the basis of the first camera and the time period, updating storage information of the first camera of a dispatching center. The video-picture hybrid storage method, apparatus and system of the present disclosure can satisfy both cost and deployment requirements, can adapt to characteristics of streaming storage demands of video surveillance, and prolong a service life cycle of storage systems, and can reduce networking requirements, so as to facilitate expansion construction.

### FIELD OF THE INVENTION

The disclosure relates to the field of video surveillance storage, in particular to a video-picture hybrid storage method, apparatus, and system.

### BACKGROUND OF THE INVENTION

Currently, video surveillance cloud storage technology is being applied in more and more scenarios to meet the need for time-streaming storage of videos, pictures, and intelligent metadata in public safety. Among them, the storage modes of each data are not the same. For example, continuous big data of video is written using continuous input/output; while captured pictures and intelligent metadata are written using random small data input/output.

Due to the different storage requirements for the above data, existing technologies usually adopt a system separation construction approach for processing. Although this processing method can meet storage requirements of each data, it also has the characteristics of varying storage technology requirements and low reuse rate of construction costs. This can easily to lead to greater difficulties in the subsequent horizontal expansion and distributed deployment, complex networking requirements, and higher construction costs.

Therefore, how to improve storage efficiency and reduce deployment difficulty while storing video surveillance data is an urgent problem that needs to be addressed.

### SUMMARY OF THE INVENTION

In view of the above deficiencies of the prior art above-mentioned, the purpose of this disclosure is to provide a video-picture hybrid storage method, apparatus and system, aimed at solving the problems of low storage efficiency and high deployment difficulty in the existing storage of video surveillance-type data.

The technical solution of the present disclosure is as follows: The present disclosure provides a video-picture hybrid storage method, apparatus, and system, the method comprises: acquiring first information collected by a first camera, the first information comprising videos, pictures and intelligent metadata; on the basis of a preset time period, storing the first information into a disk; storing position information corresponding to the first information into a first server; and, on the basis of the first camera and the time period, updating storage information of the first camera of a dispatching center.

In an embodiment of the present disclosure, on the basis of a preset time period, storing the first information into a disk; storing position information corresponding to the first information into a first server comprises: on the basis of the time period, storing the first information corresponding to the first time period into a first storage area of the disk; acquiring a first position of the first information in the first storage area at a start time in the first time period; on the basis of the first position, acquiring all offset positions of the first information within the time period; storing the first position and the offset positions into the first server.

In an embodiment, the step of on the basis of the time period, storing the first information corresponding to the first time period into a first storage area of the disk comprises: storing the first information in a cache in a queue manner; on the basis of the time period and capacity of the disk, storing the first information into the first storage area.

In an embodiment of the present disclosure, the storage information comprises: storage node information corresponding to the first camera, time period information corresponding to the first camera.

In an embodiment of the present disclosure, after the step of updating storage information of the first camera of a dispatching center, the method further comprises: on the basis of the time period information and a preset number of days of retention, when it is judged that storage time of the first information is greater than or equal to the number of days of retention, the first information and the position information are deleted according to the storage node information and time period information.

The present disclosure provides a video-picture hybrid storage apparatus, the apparatus comprises: an acquisition module for acquiring first information captured by a first camera, the first information comprising videos, pictures and intelligent metadata; a first processing module for storing the first information to a disk based on a preset time period; and storing position information corresponding to the first information into a first server; a second processing module for updating storage information of the first camera of a scheduling center based on the first camera and the time period.

In an embodiment of the present disclosure, the first processing module is specifically used for: on the basis of the time period, storing the first information corresponding to the first time period into a first storage area of the disk; acquiring a first position of the first information in the first storage area at a start time in the first time period; on the basis of the first position, acquiring all offset positions of the first information within the time period; storing the first position and the offset positions into the first server.

In an embodiment of the present disclosure, the step of on the basis of the time period, storing the first information corresponding to the first time period into a first storage area of the disk comprises: storing the first information in a cache in a queue manner; on the basis of the time period and capacity of the disk, storing the first information into the first storage area.

The present disclosure provides a storage medium storing program instructions, wherein the program instructions, when executed, implement the steps of the mixed storage method for views.

The present disclosure provides a video-picture hybrid storage system, the system comprises: a camera, a storage system, a storage service block, a dispatching center and a distributed recording node; the distributed recording node comprises the storage system and the storage service block; the camera is connected to the storage service block, for storing the first information collected by the camera in a cache of the storage service block; the storage service block is connected to the storage system, for storing the first information in the storage system based on a preset time period; the storage service block is further used for storing the position information corresponding to the first information in a first server; the first server is located within the storage service block; the dispatching center is connected to the distributed recording node, for updating storage information of the camera based on the camera and the time period.

As mentioned above, the video-picture hybrid storage method, apparatus and system of the present disclosure have the following beneficial effects:
(1) By adopting a combination of mixed storage and data indexing for processing, they can satisfy both cost and deployment requirements.
(2) They can adapt to characteristics of streaming storage demands of video surveillance, and prolong a service life cycle of storage systems.
(3) They can reduce networking requirements, so as to facilitate expansion construction.

### BRIEF DESCRIPTION OF THE DRAWINGS

FIG. 1 shows a schematic diagram of a flow of the video-picture hybrid storage method in an embodiment of the present disclosure.

FIG. 2 shows a schematic diagram of a storage instance of the video-picture hybrid storage method of in an embodiment the present disclosure.

FIG. 3 shows a schematic diagram of storage expiration deletion of the video-picture hybrid storage method in an embodiment of the present disclosure.

FIG. 4 shows a schematic diagram of a structure of the video-picture hybrid storage apparatus in an embodiment of the present disclosure.

FIG. 5 shows a schematic diagram of a system of the video-picture hybrid storage apparatus in an embodiment of the present disclosure.

### DETAILED DESCRIPTION OF THE INVENTION

The present disclosure provides a video-picture hybrid storage method, apparatus, and system, which is described in further detail below for the purpose of making the objects, technical solutions, and effects of the present disclosure clearer and more explicit. It should be understood that the specific embodiments described herein are only for explaining the present disclosure and are not intended to limit the present disclosure.

The video-picture hybrid storage method, device, and system provided by this disclosure adopt a combination of mixed storage and data indexing for processing, can satisfy both cost and deployment requirements; can adapt to characteristics of streaming storage demands of video surveillance, and prolong a service life cycle of storage systems; can reduce networking requirements, so as to facilitate expansion construction.

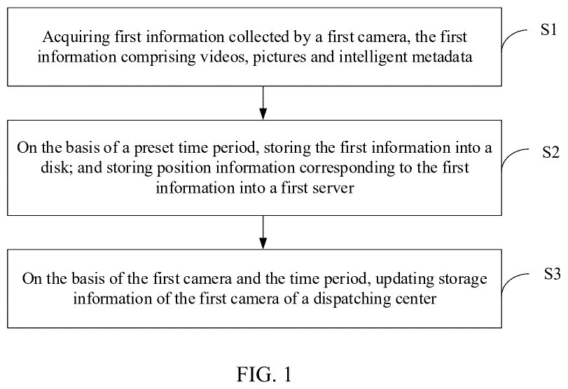

As shown in FIG. 1, in an embodiment, the video-picture hybrid storage method of the present disclosure comprises the following steps:

Step S1: Acquiring first information collected by a first camera, the first information comprising videos, pictures and intelligent metadata;

Specifically, the first information comprises a plurality of data collected by the camera, and the intelligent metadata is descriptive information data based on the videos or the pictures.

Step S2: On the basis of a preset time period, storing the first information into a disk; and storing position information corresponding to the first information into a first server.

Specifically, the step S2 comprises: on the basis of the time period, storing the first information corresponding to the first time period into a first storage area of the disk; acquiring a first position of the first information in the first storage area at a start time in the first time period; on the basis of the first position, acquiring all offset positions of the first information within the time period; storing the first position and the offset positions into the first server.

Further specifically, the step of on the basis of the time period, storing the first information corresponding to the first time period into a first storage area of the disk comprises: storing the first information in a cache in a queue manner; on the basis of the time period and capacity of the disk, storing the first information into the first storage area.

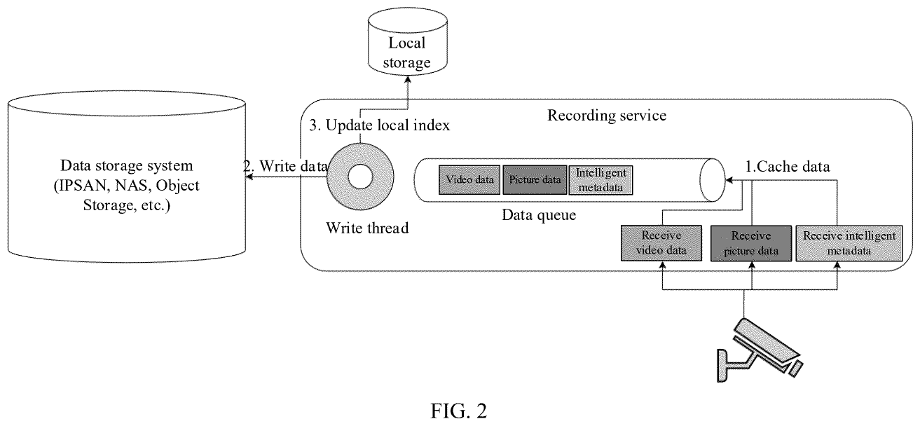

As shown in FIG. 2, is a schematic diagram of a storage instance in an embodiment of the present disclosure. For instance, the preset time period is 1 hour, the camera collects first information for a first time period of 9:00-10:00, stores the first information in a cache in a queue manner, and then stores the first information sequentially into a first storage area of a disk; for example, if a picture is collected at 9:00, acquires a first position of the picture in the first storage area; on the basis of the first position, acquires offset positions of each video, picture, and intelligent metadata between 9:00 and 10:00, and stores the first position and these offset positions into a first server. And when storing the first information into the first storage area of the disk, determining storage capacity of the first storage area based on the capacity size of the disk to ensure that the first information is written in integer multiples of the strip size of the disk and does not exceed the storage capacity of the first storage area.

Step S3: On the basis of the first camera and the time period, updating storage information of the first camera of a dispatching center.

Specifically, the storage information comprises: storage node information corresponding to the first camera, time period information corresponding to the first camera.

Further specifically, after the step of updating storage information of the first camera of a dispatching center, the method further comprises: on the basis of the time period information and a preset number of days of retention, when it is judged that storage time of the first information is greater than or equal to the number of days of retention, the first information and the position information are deleted according to the storage node information and time period information.

For example, the dispatching center is connected to a plurality of distributed recording nodes, and the first camera is connected to the first distributed recording node, i.e., the storage node information corresponding to the first camera is the first distributed recording node. For instance, the time when the first camera has collected the first information is up to 12:00 noon, and the time of the first information collected now is 1 hour as the time period, that is, the first information of 12:00-13:00. When the first information of this time period is stored into a disk, and the position information corresponding to the first information is stored in the first server, it is necessary to update the information of the time period 12:00-13:00 to the dispatching center.

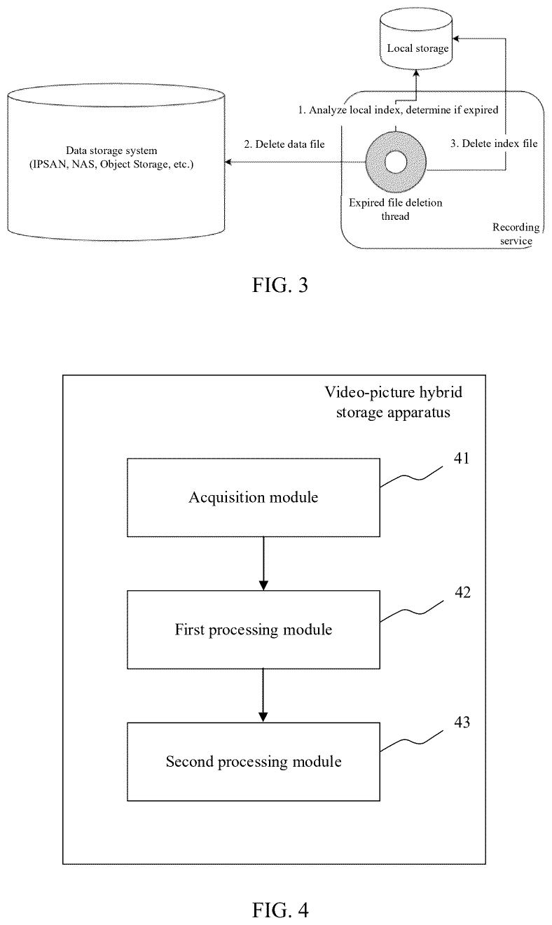

As shown in FIG. 3, is a schematic diagram of storage expiration deletion in an embodiment of the present disclosure. For instance, the first information is preset with the number of days of retention of 10 days. and when it is judged that the current time minus the time of storage of the first information in the dispatching center is greater than 10 days, it is necessary to carry out a deletion operation; Specifically, based on the storage information corresponding to the first camera corresponding to the first information in the dispatching center, as well as the time period information the first information, the first information in the disk of the corresponding time period is deleted, and the position information in the corresponding first server is deleted, and then the time period information corresponding to the first information in the scheduling center is deleted.

The method of steps S1-S3 above, by adopting a combination of hybrid storage and data indexing for processing can improve the continuous storage performance of videos, pictures and intelligent metadata; For the deletion operation of expired data, it can also ensure that the file system runs for a long time without fragmentation and performance degradation; It can satisfy both cost and deployment requirements; It can adapt to characteristics of streaming storage demands of video surveillance, and prolong a service life cycle of storage systems; It can reduce networking requirements, so as to facilitate expansion construction.

As shown in FIG. 4, is a video-picture hybrid storage apparatus of in an embodiment of the present disclosure, which comprises:
an acquisition module for acquiring first information collected by a first camera, the first information comprising videos, pictures and intelligent metadata;
a first processing module for storing the first information to a disk based on a preset time period; and storing position information corresponding to the first information into a first server;
a second processing module for updating storage information of the first camera of a dispatching center based on the first camera and the time period.

Wherein, the first processing module is specifically used for: on the basis of the time period, storing the first information corresponding to the first time period into a first storage area of the disk; acquiring a first position of the first information in the first storage area at a start time in the first time period; on the basis of the first position, acquiring all offset positions of the first information within the time period; storing the first position and the offset positions into the first server.

Further specifically, the step of on the basis of the time period, storing the first information corresponding to the first time period into a first storage area of the disk comprises: storing the first information in a cache in a queue manner; on the basis of the time period and capacity of the disk, storing the first information into the first storage area.

The technical features specifically realized by the video-picture hybrid storage apparatus in this embodiment are basically the same as the principles of the respective steps in the video-picture hybrid storage method in the embodiment, and the technical contents that can be used interchangeably between the method and the apparatus will not be repeated.

The storage medium of the present disclosure stores a computer program, the program, when executed by a processor, implements the above-mentioned video-picture hybrid storage method.

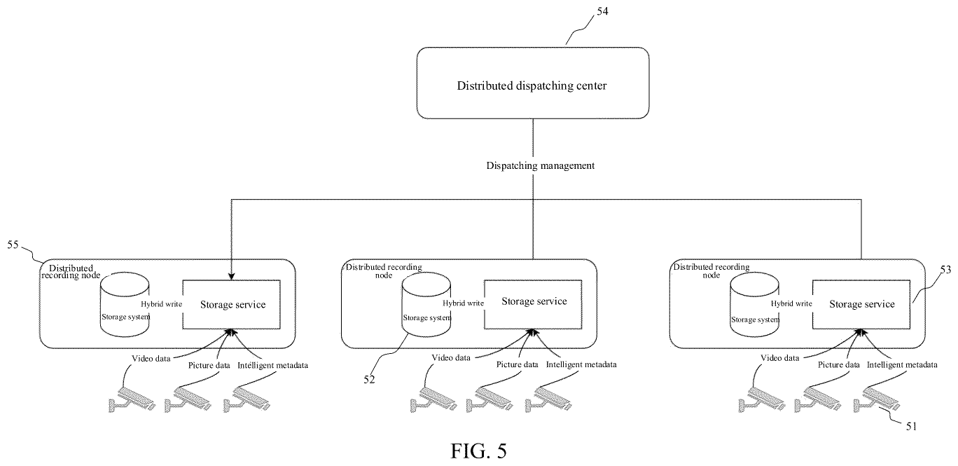

As shown in FIG. 5, is a video-picture hybrid storage system in an embodiment of the present disclosure, which comprises: a camera 51, a storage system 52, a storage service block 53, a dispatching center 54, and a distributed recording node 55; the distributed recording node 55 comprises the storage system 52 and the storage service block 53; the camera 51 is connected to the storage service block 53, for storing first information collected by the camera in a cache of the storage service block 53; the storage service block 53 is connected to the storage system 52, for storing the first information into the storage system 52 based on a preset time period; the storage service block 53 is further used for storing position information corresponding to the first information into a first server; the first server is located within the storage service block 53; the dispatching center 54 is connected to the distributed recording node 55, for updating storage information of the camera 51 based on the camera 51 and the time period.

In summary, the video-picture hybrid storage method, device, and system provided by the present disclosure adopt a combination of hybrid storage and data indexing for processing, can satisfy both cost and deployment requirements; can adapt to characteristics of streaming storage demands of video surveillance, and prolong a service life cycle of storage systems; can reduce networking requirements, so as to facilitate expansion construction.

It should be understood that the application of the present disclosure is not limited to the examples mentioned-above. For those of ordinary skill in the art, improvements or variations can be made based on the above description, and all such improvements and variations should fall within the scope of protection of the appended claims of the present disclosure. That is, the foregoing are merely embodiments of the present disclosure and do not thereby limit the patentable scope of the present disclosure, and the terms “comprising,” “including,” or any other variations thereof herein are intended to cover a non-exclusive inclusion, so that a process, function or method including a series of elements not only includes those elements, but also includes other elements that are not explicitly listed, or further includes elements inherent to such process, function, or method. Any equivalent structural or functional variations made using the content of the present disclosure and its drawings, or their direct or indirect application in other related technical fields, are likewise included within the scope of patent protection of the present disclosure.

What is claimed is:

1. A video-picture hybrid storage method, which comprises:
acquiring first information collected by a first camera, the first information comprising videos, pictures and intelligent metadata;
on the basis of a preset time period, storing the first information into a disk;
storing position information corresponding to the first information into a first server; and,
on the basis of the first camera and the time period, updating storage information of the first camera of a dispatching center.

2. The method as claimed in claim 1, wherein the step of on the basis of a preset time period, storing the first information into a disk; storing position information corresponding to the first information into a first server comprises:
on the basis of the time period, storing the first information corresponding to the first time period into a first storage area of the disk;
acquiring a first position of the first information in the first storage area at a start time in the first time period;
on the basis of the first position, acquiring all offset positions of the first information within the time period; storing the first position and the offset positions into the first server.

3. The method as claimed in claim 2, wherein the step of on the basis of the time period, storing the first information corresponding to the first time period into a first storage area of the disk comprises:
storing the first information in a cache in a queue manner;
on the basis of the time period and capacity of the disk, storing the first information into the first storage area.

4. The method as claimed in claim 1, wherein the storage information comprises:
storage node information corresponding to the first camera, time period information corresponding to the first camera.

5. The method as claimed in claim 4, wherein after the step of updating storage information of the first camera of a dispatching center, further comprises:
on the basis of the time period information and a preset number of days of retention, when it is judged that storage time of the first information is greater than or equal to the number of days of retention, the first information and the position information are deleted according to the storage node information and time period information.

6. A video-picture hybrid storage apparatus, which comprises:
an acquisition module for acquiring first information collected by a first camera, the first information comprising videos, pictures and intelligent metadata;
a first processing module for storing the first information to a disk based on a preset time period; and storing position information corresponding to the first information into a first server;
a second processing module for updating storage information of the first camera of a dispatching center based on the first camera and the time period.

7. The apparatus as claimed in claim 6, wherein the first processing module is specifically used for:
on the basis of the time period, storing the first information corresponding to the first time period into a first storage area of the disk;
acquiring a first position of the first information in the first storage area at a start time in the first time period;
on the basis of the first position, acquiring all offset positions of the first information within the time period;
storing the first position and the offset positions into the first server.

8. The apparatus as claimed in claim 7, wherein the step of on the basis of the time period, storing the first information corresponding to the first time period into a first storage area of the disk comprises:
storing the first information in a cache in a queue manner;
on the basis of the time period and capacity of the disk, storing the first information into the first storage area.

9. A storage medium storing program instructions, wherein the program instructions, when executed, implement the steps of the video-picture hybrid storage method as claimed in claim 1.

10. A video-picture hybrid storage system, which comprises:
a camera, a storage system, a storage service block, a dispatching center, and a distributed recording node;
the distributed recording node comprises the storage system and the storage service block;
the camera is connected to the storage service block, for storing first information collected by the camera in a cache of the storage service block;
the storage service block is connected to the storage system, for storing the first information into the storage system based on a preset time period;
the storage service block is further used for storing position information corresponding to the first information into a first server; the first server is located within the storage service block;
the dispatching center is connected to the distributed recording node, for updating storage information of the camera based on the camera and the time period.
